(19) United States
(12) Patent Application Publication
(10) Pub. No.: US 2011/0302103 A1
(43) Pub. Date: Dec. 8, 2011

(54) POPULARITY PREDICTION OF USER-GENERATED CONTENT

(75) Inventors: David Carmel, Haifa (IL); Haggai Roitman, Qiryat-Ata (IL); Elad Yom-Tov, Mizpe Hoshaya (IL)

(73) Assignee: International Business Machines Corporation, Armonk, NY (US)

(21) Appl. No.: 12/795,684

(22) Filed: Jun. 8, 2010

(51) Int. Cl. G06Q 99/00; G06Q 50/00

(52) U.S. Cl. 705/347

(57) ABSTRACT

A method, system, and computer program product for popularity prediction of user-generated content are provided. The method includes measuring the novelty of a user-generated content and predicting the popularity of the user-generated content based on the measured novelty. Predicting the popularity of the user-generated content includes: extracting basic features of the user-generated content; measuring novelty features of the user-generated content; and predicting the popularity based on the basic features and novelty features. Measuring the novelty of a user-generated content includes one or more of: measuring a relative novelty of the user-generated content with respect to the contribution history of the same user in a given time period; measuring a relative novelty of the user-generated content with respect to user-generated content of other users in a given time period; and measuring a relative novelty of the user-generated content with respect to the references by other users to the user-generated content.

### BACKGROUND

This invention relates to the field of user-generated content. In particular, the invention relates to popularity prediction of user-generated content.

Recent years have witnessed a tremendous increase in the amount of user-generated content available on the web. Many Web 2.0 applications have emerged to provide an open stage for users to publicly share their ideas and opinions with others. For example, blogging web services such as Blogger (www.blogger.com) (Blogger is a trade mark of Google Inc.) and ReadWriteWeb (www.readwriteweb.com) (ReadWriteWeb is a trade mark of ReadWriteWeb), have become popular media for personal content publication.

More recently, microblogging services, such as Twitter (www.twitter.com) (Twitter is a trade mark of Twitter, Inc.), let users publish short comments about breaking world news as well as daily updates about themselves. Furthermore, such social media sites have been recognized as an important arena in which user-generated content can be directly used to shape public opinion and trends, and to influence the attitudes of potential customers by applying commercial marketing campaigns.

As the popularity of social media services increases, identifying those sites with high “content quality” becomes more difficult due to the enormous amount of new content that is continually published on those sites. Typically, due to the large amounts of data, only a small fraction of new content is expected to gain popularity. Consequently, only a small amount of user-generated content will be read, commented, or rated by others, while most of the content will be ignored.

The quality of user-generated content is usually measured in several dimensions such as the author's reputation, objectivity, and reliability, as well as content relevancy, completeness, and accuracy. The most successful indicators for user content quality are the amount of user feedback and the number of citations the post has. These approaches usually rely on explicit and publicly available feedback such as comments, ratings, recommendations, and tagging, as well as implicit feedback such as click-through data.

User feedback is indeed very valuable for identifying high quality content. However, there remains a gap in user-generated content quality evaluation when no feedback is available, especially for freshly published content. When user feedback does not exist, evaluation approaches are mostly based on the author's reputation, as reflected by the popularity of the author's previous posts. However, such methods are strongly biased to popular contributors in the past, and underestimate the content published by unfamiliar contributors.

### BRIEF SUMMARY

According to a first aspect of the present invention there is provided a method for popularity prediction of user-generated content, comprising: measuring the novelty of a user-generated content; predicting the popularity of the user-generated content based on the measured novelty; wherein said steps are implemented in either: computer hardware configured to perform said identifying, tracing, and providing steps, or computer software embodied in a non-transitory, tangible, computer-readable storage medium.

According to a second aspect of the present invention there is provided a computer program product for popularity prediction of user-generated content, the computer program product comprising: a computer readable storage medium having computer readable program code embodied therewith, the computer readable program code comprising: computer readable program code configured to: measuring the novelty of a user-generated content; predicting the popularity of the user-generated content based on the measured novelty.

According to a third aspect of the present invention there is provided a system for popularity prediction of user-generated content, comprising: a processor; a novelty measuring component for measuring the novelty of a user-generated content; and a predictor for predicting the popularity of the user-generated content based on the measured novelty.

According to a fourth aspect of the present invention there is provided a service to a customer over a network for popularity prediction of user-generated content, comprising: measuring the novelty of a user-generated content; predicting the popularity of the user-generated content based on the measured novelty; wherein said steps are implemented in either: computer hardware configured to perform said identifying, tracing, and providing steps, or computer software embodied in a non-transitory, tangible, computer-readable storage medium.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram illustrating novelty in blogs in accordance with the present invention;

FIG. 2 is a flow diagram of a method in accordance with the present invention;

FIG. 3 is a block diagram of a system in accordance with the present invention; and

FIG. 4 is a block diagram of a computer system in which the present invention may be implemented

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described for predicting popularity of user-generated content based on novelty of the content.

User-generated content may be any content made available publicly via a network by a user, including, but not limited to, blog content, microblog content, web posted articles, academic papers, etc.

The novelty of a user-generated content plays an important role in affecting its popularity. Three dimensions of novelty types are described which are used for prediction of the popularity of the user-generated content.

The first type of novelty, termed contemporaneous novelty, models the relative novelty embedded in new user-generated content with respect to contemporary content generated by others. It is hypothesized that non-novel user contents are less popular since they fail to explore new valuable information for the content consumers (e.g., blog readers).

The second type of novelty, termed self novelty, models the relative novelty embedded in new user-generated content with respect to the user's own contribution history. Self novelty measures the novelty of a new user content with respect to previous contents published on the same content source (user). Self novelty contributes to content popularity, probably due to the fact that authors who repeat themselves and fail to innovate, lose their readers over time.

The third novelty type, termed discussion novelty, relates to the novelty of the feedback (e.g., comments, tags, ratings) associated by readers with previous user contents published on the same content source. The feedback of each previous user content is compared to their associated content for measuring the amount of information the feedback added to the original user content. The assumption behind this measure is that a new content, contributed by an author with a history of high discussion novelty, is also likely to initiate a stimulating on-line discussion that will affect the content's popularity.

The novelty features described above do not require existing user feedback. Therefore, they can enhance existing popularity estimation techniques for new user-generated contents, which are currently based primarily on the author's reputation and on textual analysis.

Furthermore, the contemporaneous novelty feature can even be used to predict the popularity of new user contents provided by unfamiliar contributors with no history at all. Such an estimation of fresh content, prior to the availability of any user feedback, is of extreme importance.

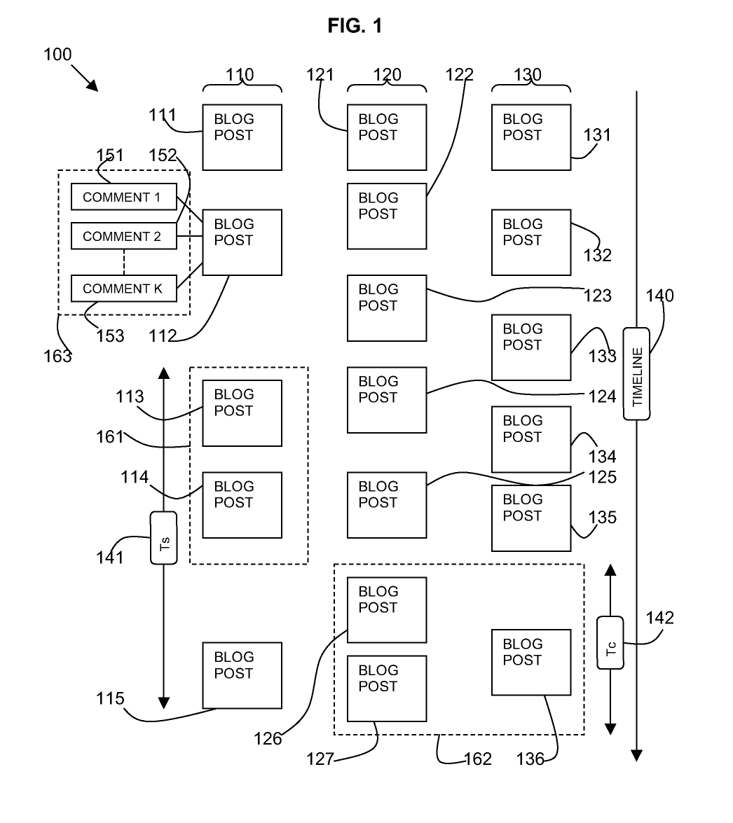

Referring to FIG. 1, a blogosphere 100 is shown as an example of user-generated contents. The context of blogs is used to describe the method; however, other forms of user-generated content may also be used, such as microblogs, articles, documents, etc.

The blogosphere 100 is a set of blogs 110, 120, 130, with each blog 110, 120, 130 being formed of a stream of blog posts 111-115, 121-127, 131-136. FIG. 1 shows the blog posts 111-115, 121-127, 131-136 as streams in a timeline 140.

Each blog post 112 may have comments 151-153 posted by readers of the blog post.

A new blog post 115 is shown in FIG. 1. Previous blog posts 114, 113 in the same blog 110 can be used to determine self novelty of the blog post 115. The time period Ts 141 from which previous blog posts 114, 113 can be used, is determined by an administrator and may be varied.

Contemporaneous blog posts 126, 127, 136 in different blogs 120, 130 within a given time as the new blog post 115 can be used to determine contemporaneous novelty of the new blog post 115. The time period Tc 142 from which contemporaneous blog posts 126, 127, 136 are used, is determined by an administrator and may be varied.

Comments 151-153 on a blog post 112 may be used to determine discussion novelty.

### DEFINITIONS

A domain of user-generated content is defined B={b₁, b₂, . . . , bₙ} as a set of streams of content, where each stream of content bεB is a stream of user-generated post updates (posts for short), usually contributed by the same author, or a community of authors who share a stream of content on the same topic. Let p_{b} denote a single post published on stream of content b. It is assumed that each post p_{b} has a timestamp t(pₕ) that captures its publication time.

Each post can further have zero to many comments from its readers. In this embodiment, comments are used as representative of the stream of content popularity. Other types of user feedback (ratings, tags, citations, reviews, annotations, etc.) can be used for this purpose in a similar way to the comments.

The sequence of comments to a post p_{b} is denoted by C(p_{b})={cl, . . . , ck}, where each comment cᵢ has its own publication time t(cᵢ). Obviously, the publication time for any comment cεC(p_{b}) satisfies t(c)>=t(p_{b}).

Three sets are defined that will be used later on to derive the proposed novelty features. FIG. 1 provides an illustration of the three sets, where a single new post 115 is illustrated at the bottom left.

Definition 1—Self Novelty Set.

Given a post p_{b}, define SN(p_{b}, T) to be the set of all posts that were published on the same stream of content b previous to post p_{b}, within a given time window T. Formally:

SN(p_{b},T)={(p_{b}|t(p_{b})−T≦t(p_{b})}

The self novelty set 161 is as applied to the blog posts of FIG. 1 is illustrated as a hashed box in FIG. 1.

Definition 2—Contemporaneous Novelty Set.

Given a post p_{b}, and a time window T, define CN(p_{b}, T) to be the set of all posts p_{b}′ that were contemporary published with post p_{b} on other streams of content within the time window T. Formally:

CN(p_{b},T)={p_{b}|b′εB\{b} [symbol] t(p_{b})−T≦t(p_{b})≦t(p_{b})}

The contemporaneous novelty set determines all posts in the content domain that were published on other streams of content, contemporary with post p_{b} in a given time window. This set of posts as applied to the blog posts of FIG. 1 is illustrated 162 as a hashed box in FIG. 1.

Definition 3—Discussion Novelty Set.

Given a post p_{b}, a sequence of comments to the post C(p_{b}), and a timestamp t, define DN(p_{b}, t) to be the set of all comments for post p_{b} that were submitted up to time t. Formally:

DN(p_{b},t)={c|cεC(p_{b}) [symbol] t(c)≦t}

The discussion novelty set 163 for a given post as applied to the blog posts of FIG. 1 is shown in a hashed box in FIG. 1.

Novelty Measurement

The novelty of a post is measured over three contextual dimensions, which are hypothesized as contributing to predicting its popularity. All three forms of novelty measurement are not always required. A combination of only two forms or even only one form may be used.

A distance measurement of two textual strings is required in the novelty measurements. In the described embodiment, a distance measure is utilized that is derived from information theory, known as the normalized compression distance (NCD). Other forms of distance measurement may be used, for example, an alternative form of distance measurement may be based on the cosine similarity measurement between two text strings (1−cos(x,y)).

Given a compressor M and two strings x and y, the NCD is defined as:

NCD(x,y)=[M(xy)−min(M(x),M(y))]/max(M(x),M(y))

where M(x), M(y) and M(xy) are the bitwise sizes of the resulting sequences when using M to compress x, y, and the concatenation of x and y, respectively. In one embodiment, the 7ZA-compression algorithm is used for the compressor M, due to its ability to utilize a large buffer which is well suited for large text. Other forms of compressor may also be use.

NCD estimates the distance between two text strings by measuring the improvement achieved by compressing one string using the information found in the other string. It has been proved to serve as an approximation of Kolmogorov complexity.

Novelty-Based Features

Several novelty features for predicting content popularity are described. This set of features can be further used along with more traditional features of the content as described further below. In the described embodiment, novelty is measured along three contextual dimensions, coined self novelty, contemporaneous novelty, and discussion novelty.

Self Novelty

This measure models the relative novelty embedded in new user-generated content with respect to the user's own contribution history. Self novelty measures the novelty of a new post with respect to previous posts published on the same stream of content. It is hypothesized that self novelty contributes to post popularity, probably due to the fact that authors who fail to innovate and to “surprise” their readers, lose their popularity over time.

Given a post p_{b} of some stream of content bεB, and a time window Tₛ; let SN(p_{b}, Tₛ) be the corresponding self novelty set (reference 161 in FIG. 1). The self novelty of post p_{b} with respect to SN(p_{b}, Tₛ) is given by:

novₛ(p_{b},Tₛ)=NCD(p_{b},concat(SN(p_{b},Tₛ)))

Note that p_{b} represents the content of the given post and concat(SN(p_{b}, Tₛ)) is the concatenation of all post contents in the SN set.

Contemporaneous Novelty

This measure evaluates the novel contribution of a stream of content post with respect to other posts submitted in the same time period. It is hypothesized that non-novel posts are less popular as they fail to explore new valuable information for their readers.
Given a post p_{b}, and a time window T_{c}; let CN(p_{b}, T_{c}) be the corresponding contemporaneous-novelty set (see reference 161 in FIG. 1). The contemporaneous novelty of post p_{b} with respect to CN(p_{b}, T_{c}) is given by:

nov_{c}(p_{b},T_{c})=NCD(p_{b},concat(CN(p_{b},T_{c})))

Discussion Novelty

This type relates to the novelty of the comments associated by readers with previous posts on the same stream of content. The comments of each previous post are compared to the original post content to measure their novelty in terms of the amount of information they add to the original post. The intuition behind this measure is that a new post on a stream of content with high discussion novelty, is more likely to initiate an interesting fruitful discussion that will affect the post's popularity.

Given a post p_{b} on some stream of content bεB. Let b′={p′_{b}εb|t(p′_{b})<t(p_{b})} be the set of all posts in b prior to p_{b}. The discussion novelty of p_{b} is measured by the average novelty of comments on previous posts on the same stream of content. More formally:

$${nov}_{d} ( {p}_{b} ) = \frac{1}{\vert {b}^{′} \vert} {\sum }_{{p}_{b}^{′} ∈ {b}^{′}} N C D ( {p}_{b}^{′} , concat ( D N ( {p}_{b}^{′} , t ( {p}_{b} ) ) ) )$$

where |b′| represents the number of previous posts on b, and concat(D(p′_{b},t(p_{b}))) is the concatenation of all comments to post p_{b}′ that were given prior to publication time of p_{b}.

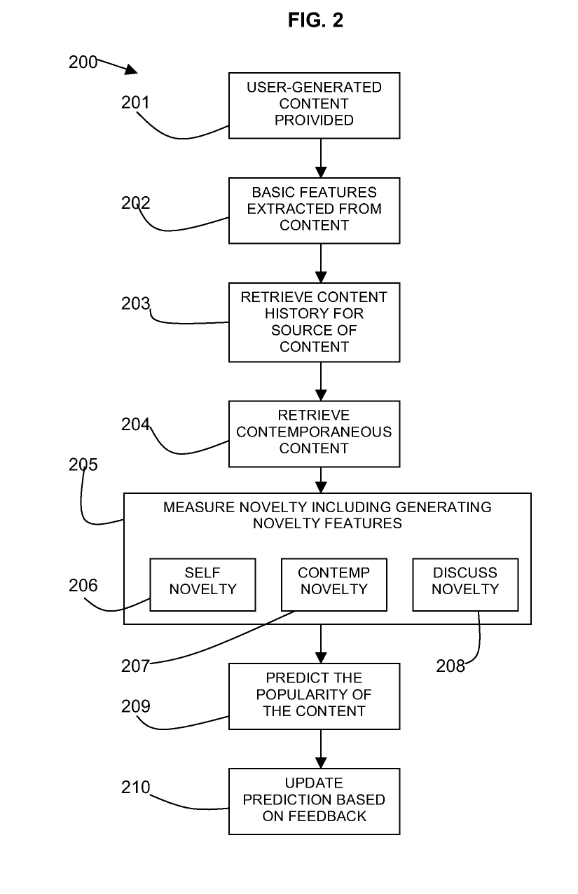

Referring to FIG. 2, a flow diagram shows a method of predicting user-generated content popularity. A user-generated content is provided 201 for evaluation. The content may be new or existing user-generated content.

Basic features are extracted 202 from the content (for example, the basic features may include text, tags, timestamp, author identity, etc.).

Using a document source identity (for example, author identity), retrieve 203 the content history of that source (for example, the last K content items generated on that source or items generated within some defined window of time). The retrieved content history of the source may include associated content (for example, comments, tags, etc.) from the content history.

Retrieve 204 contemporaneous content published on other sources (authors) with respect to the given content to evaluate. Contemporaneous content may be retrieved that was published within some time window, or K last updates from each source may be retrieved.

Novelty is measured 205 for user-generated content including generating novelty features. The novelty measure uses three novelty contexts of self novelty 206, contemporaneous novelty 207, and discussion novelty 208. Not all of the novelty contexts need to be used. For example, one of the novelty contexts may be used, a combination of two of the novelty contexts may be used, or all three novelty contexts may be used. Measuring the novelty in each case applies a distance measurement between the user-generated content and reference content.

Given the basic features from step 202 and the novelty features from step 205, a predictor predicts 209 the popularity of the content. Predicting the popularity of the user-generated content may be based on the prediction of the expected number of references to the user-generated content, such as comments, citations, tags, etc.

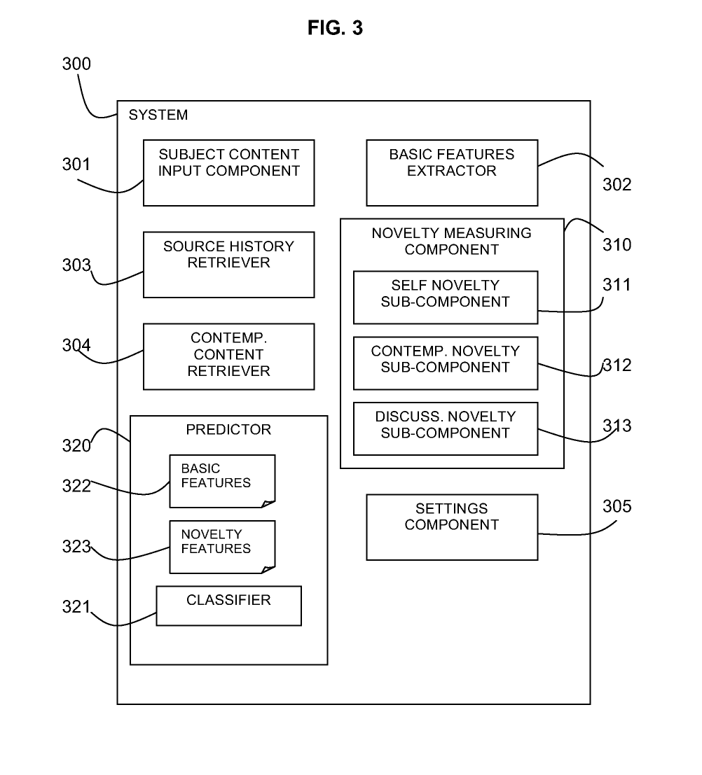

Referring to FIG. 3, a block diagram shows a system 300 for popularity prediction of user-generated content. The system 300 includes a subject content input component 301 for inputting or getting the subject content for evaluation. A basic features extractor 302 extracts basic features from the subject content to be evaluated.

A source history retriever 303 retrieves content history from the same source as the subject content using the subject content's source identity within a defined time window. This may include retrieving all associated content such as comments, tags, etc.

A contemporaneous contents retriever 304 retrieves contemporaneous content published on other sources with respect to a defined time window.

A novelty measuring component 310 includes three sub-components for measuring self novelty 311, contemporaneous novelty 312, and discussion novelty 313 for the subject content. One or more of the sub-components 311, 312, 313 may be used for a given subject content.

A predictor 320 is provided including a classifier 321 for classifying the subject content with respect to a pre-defined popularity measure. For example, based on the number of comments or citations on the subject content. The predictor 320 uses the basic features 322 from the basic features extractor 302 and the novelty features 323 from the novelty measuring component 310.

A settings component 305 enables input of user settings, including: the time windows used by the source history retriever 303 and the contemporaneous contents retriever 304, the novelty measurement algorithm to be used by the novelty measuring component 310, the prediction classifier algorithm to be used by the classifier 321, and the pre-defined popularity measure used by the predictor 320.

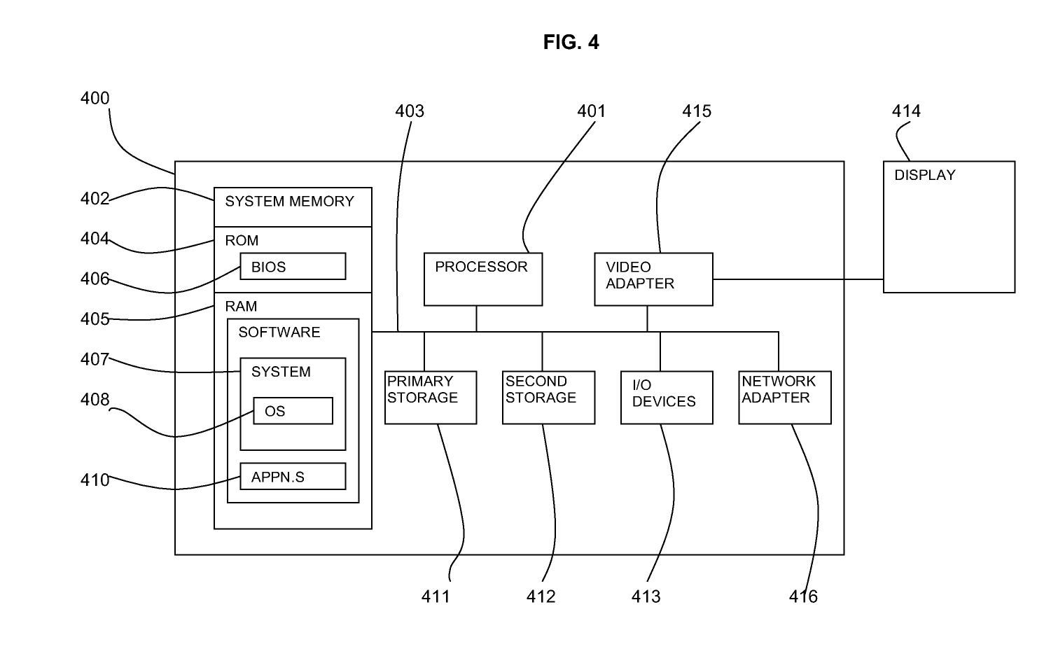

Referring to FIG. 4, an exemplary system for implementing aspects of the invention includes a data processing system 400 suitable for storing and/or executing program code including at least one processor 401 coupled directly or indirectly to memory elements through a bus system 403. The memory elements can include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 can be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

The following is a description of the features used by the novelty-based predictor based on basic features and described novelty features. Two example embodiments are described based on two use cases. In the first example embodiment, a future blog post popularity is determined as indicated by the number of its expected comments. In the second example embodiment, it is shown how the prediction can be applied to other domains, focusing on the task of predicting academic paper citation volume.

In the first example embodiment of the blog post popularity prediction, several basic features are extracted from each blog post to be used by the popularity predictor. These features include the post's raw text, the time, the date of its publication, the number of comments it received, as well as the comments' raw text and publication time, the number of tags the post was tagged with as well as its average rating value. The relative activity of the blog's author was also measures (average and standard deviation). Table 1 below shows the features used in the prediction including the three novelty based features described above.

TABLE 1

| | Feature Name | Description |
|---|---|---|
| Blog Features | num_comments | Average and standard deviation of the |
| | | number of comments given to previous |
| | | posts on the same blog. |
| | rating | Average and standard deviation of the |
| | | rating given to previous posts on the |
| | | same blog. |
| | num_tags | Average and standard deviation of the |
| | | number of tags given to previous posts |
| | | published on the same blog. |
| | num_recommendations | Average and standard deviation of the |
| | | number of recommendations given to |
| | | previous posts published on the same |
| | | blog. |
| | num_unique_commenters | Average and standard deviation of the |
| | | number of unique commenters to |
| | | previous posts published on the same |
| | | blog. |
| | blogger_activity | Relative publication rate of the blog's |
| | | author. |
| | avg_post_length | Average and standard deviation of the |
| | | length of previous posts published on the |
| | | same blog. |
| Post Features | post_length | Post length. |
| | timestamp | Post publication time and date. |
| Novelty Features | self_novelty | Self novelty of a post given its SN set. |
| | contemporaneous_novelty | Contemporaneous novelty of a post |
| | | given its CN set. |
| | discussion_novelty | Discussion novelty of a post given its |
| | | DN set. |

The goal in the first example embodiment is to predict whether a new blog post would receive a total of N or more comments in the future, by learning a predictor that is based on the features described in Table 1.

In this embodiment, two binary classifiers are used for prediction: Linear Regression and a Decision Tree. The goal of the classifier is to separate those blog posts with N or more comments from all other posts. Given a new blog post, the predictor will then classify it into either of the two classes.

Ten-fold cross validation was used to reduce the chance of over-fitting. The accuracy of each predictor can be measured by the area under the corresponding ROC (receiver operating characteristic) curve.

The performance of the predictor can be analyzed for different parameter settings. In order to obtain the self novelty and contemporaneous novelty features, time windows for which the SN and CN sets are derived respectively must be determined.

It has been observed that the area under the ROC curve tends to saturate at around 120 days for every value of N, and any improvement thereafter is relatively small. This indicates that the effective horizon for blog posts is approximately 4 months, with longer horizons adding relatively little information. The effect of Tc was also examined in a similar manner, and was found to reach a plateau at Tc=10 days. Its overall effect on the ROC was negligible.

Table 2 below shows the different thresholds (N) on the number of comments estimated in the first embodiment, as well as the fraction of blog posts with at least this number of comments, and the area under the ROC curve that the linear regression predictor reached. The ROC area is given for Ts=120 days and Tc=10 days. Note that the threshold determines whether the blog post will have at least N comments. Therefore, the predictor for N≧1 also predicts the complementary decision of no comments at all.

TABLE 2

| | Percentage of posts with at | Area under the ROC curve |
|---|---|---|
| Threshold N | least N comments | for the learned predictor |
| ≧1 | 31% | 0.66 |
| ≧2 | 18% | 0.68 |
| ≧3 | 4% | 0.73 |
| ≧4 | 1% | 0.77 |

Table 2 shows that it is easier to identify blog posts with many expected comments than to distinguish between blog posts which will not be commented to and those blog posts which will have at least one comment. This is attributed to the fact that most blog posts that receive many comments tend to come from blogs which have a persistent following over time.

Looking deeper into the predictor performance analysis, the most influential features used by the predictor were identified by normalizing each feature to zero mean and unit variance, and ranking the weights learned by the predictor in decreasing order of absolute magnitude. Using this method, the most influential features (in decreasing order of importance) were: 1) Discussion-novelty; 2) Self-novelty; 3) Average number of comments to previous posts; 4) Standard deviation of discussion-novelty.

The relative contribution of each of these features can be estimated by building a predictor with the most influential feature, the two most influential features, etc. According to analysis, even when using a single feature, it is easier to identify posts which will receive many (more than 10) comments, compared to posts which will receive one or more comments. Furthermore, the average number of comments to previous posts is mostly influential when identifying blog posts which will receive 10 or more comments, and self-novelty contributes more to this prediction task.

A second example embodiment, illustrates how the novelty-based predictor can be generalized to the task of citation prediction for academic papers.

In this embodiment, the dataset is publications made by a single academic community, and it is assumed that enough time has passed since the publication of the last paper in the collection to allow reasonable exposure time.

For each paper, similar features were extracted to those described in Table 1. The first set of features included the average and standard deviation of the past number of citations for papers by the author, the number of unique authors who cited papers by the same author, and the paper length. If there were several co-authors for a paper, the maximum, minimum, and average of the attributes for each author was taken. Given a paper and time windows Ts and Tc, papers were identified that belong to its self novelty set and contemporaneous novelty set, respectively, from which the paper self novelty and contemporaneous novelty features were calculated. In this embodiment for papers, the discussion novelty is not measured since paper citations are not accompanied with text compared to blog post comments.

The required prediction was if the number of citations that a paper will have in the future will be N or more. Ten-fold cross validation was used to reduce the chance of over-fitting. Because of the relatively short time span of the data, the time periods were set as Ts=5 years and Tc=1 year. Two classifiers were used for prediction: Linear Regression and a Decision Tree.

Table 3 below shows the thresholds at which the predictor was evaluated, as well as the resulting area under the ROC curve, while setting Ts=5 years and Tc=1 years. It can be observed from Table 4 that, overall, similar results are obtained to those for blogs, with a relatively high prediction accuracy for the number of citations. Finally, similarly to the analysis for blogs, for papers it was found that the most influential features of the predictor at a threshold of N≧10 were (in decreasing order of importance): 1) The minimum (between authors) of the average contemporaneous novelty; 2) The maximum (between authors) of contemporaneous novelty; 3) The maximum (between authors) of the number of papers published by the author; 4) The maximum (between authors) of self novelty.

TABLE 3

| | | Area under the ROC curve |
|---|---|---|
| Threshold N | Percentage of papers | for the learned predictor |
| ≧1 | 83% | 0.66 |
| ≧2 | 75% | 0.64 |
| ≧5 | 54% | 0.69 |
| ≧10 | 42% | 0.70 |

Content providers should provide novel writing in order to get attention to their content. Attractive posts are those that are novel with respect to contemporaneous published content, as well as novel with respect to previous content published on the same source. In addition, posts that are able to trigger stimulating on-line discussion have high potential to become popular. By measuring the three novelty dimensions of a post it is demonstrated how the novelty features can contribute to the task of predicting the amount of expected comments. The same novelty-based features can assist in predicting the popularity of other user-generated content, such as citation volume of academic papers.

The task of predicting user-generated content popularity as reflected by the amount of expected user feedback is described, including new generated content that has not yet received feedback. The proposed prediction method can be used to derive many useful applications, such as the following:
Ranking user-generated content (for example, for search and recommendation);
Identification of important social media content (for example, blogs) for purposes such as influencers' detection and viral marketing in social media, and
Recommendation tools, such as tools for providing immediate feedback to bloggers about the estimated impact their new post would receive or to content management systems to assist them in deciding on content display policies (for example, which blogs to present on the front page of a blogging site main page).

Using real-world blog data, the effectiveness has been demonstrated of the novelty measures described in assisting to predict the number of comments expected for new blog posts. The novelty-based predictor is able to predict posts that will not be commented on at all with an accuracy (as measured by the area under the ROC curve) of 66%; posts with at least 5 comments with an accuracy of 73%; and highly commented on posts (with more than 10 comments) with an accuracy of 77%. Based on the assumption that the amount of feedback reflects blog post quality, the novelty-based predictor is able to identify high-quality blog posts with high precision.

The novelty features described above do not require existing user feedback. Therefore, they can enhance existing popularity estimation techniques for new user-generated contents, which are currently based primarily on the author's reputation and on textual analysis.

Furthermore, the contemporaneous novelty feature can even be used to predict the popularity of new user contents provided by unfamiliar contributors with no history at all. Such an estimation of fresh content, prior to the availability of any user feedback, is of importance.

For example, the success of commercial marketing campaigns in the blogosphere strongly depends on identifying those blogs expected to a have high potential for reaching large audiences and influencing their readers. This is also true for recommendation services, which recommend interesting blogs to their customers. Most existing blogging websites recommend a short list of high quality blog posts on their main page. This list is usually composed of the latest top-rated and commented posts, as well as new posts of authors who were popular in the past. Given the ability to predict the expected volume of comments for new posts will enable better identification of high quality posts in advance, when no feedback is available yet. It will also allow those recommendation tools to identify interesting blog-posts immediately after publication, independent of their future recognition by the society.

A popularity prediction of user-generated content may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for popularity prediction of user-generated content, comprising:
measuring the novelty of a user-generated content; and
predicting the popularity of the user-generated content based on the measured novelty

2. The method as claimed in claim 1, wherein predicting the popularity of the user-generated content includes:
extracting basic features of the user-generated content;
measuring novelty features of the user-generated content; and
predicting the popularity based on the basic features and novelty features.

3. The method as claimed in claim 1, wherein predicting the popularity of the user-generated content predicts the expected number of references to the user-generated content using a binary classifier.

4. The method as claimed in claim 1, wherein measuring the novelty of a user-generated content includes:
applying a distance measurement between the user-generated content and reference content.

5. The method as claimed in claim 1, wherein measuring the novelty of a user-generated content includes:
measuring a relative novelty of the user-generated content with respect to the contribution history of the same user in a given time period.

6. The method as claimed in claim 1, wherein measuring the novelty of a user-generated content includes:
measuring a relative novelty of the user-generated content with respect to user-generated content of other users in a given time period.

7. The method as claimed in claim 1, wherein measuring the novelty of a user-generated content includes:
measuring a relative novelty of the user-generated content with respect to the references by other users to the user-generated content.

8. The method as claimed in claim 1, wherein the user-generated content is newly published content.

9. The method as claimed in claim 1, wherein the user-generated content is a blog post and measuring the novelty of a user-generated content includes:
measuring a relative novelty of the blog post with respect to blog post in the same blog in a given time period;
measuring a relative novelty of the blog post with respect to blog posts in other blogs in a given time period; and
measuring a relative novelty of the blog post with respect to comments on the blog post.

10. The method as claimed in claim 1, wherein the user-generated content is an article and measuring the novelty of a user-generated content includes:
measuring a relative novelty of the article with respect to articles by the same author in a given time period;
measuring a relative novelty of the article with respect to articles by other authors in a given time period.

11. The method as claimed in claim 1, wherein predicting the popularity of the user-generated content predicts the number of references to the user-generated content wherein the references are one or more of the group of: comments, citations, tags.

12. The method as claimed in claim 1, including retrieving the contribution history of the same user in a given time period using a source identification of the user-generated content.

13. The method as claimed in claim 1, including updating the prediction based on feedback.

14. A computer program product for popularity prediction of user-generated content, the computer program product comprising:
a computer readable storage medium having computer readable program code embodied therewith, the computer readable program code comprising:
computer readable program code configured to:
measuring the novelty of a user-generated content;
predicting the popularity of the user-generated content based on the measured novelty.

15. A system for popularity prediction of user-generated content, comprising:
a processor;
a novelty measuring component for measuring the novelty of a user-generated content; and
a predictor for predicting the popularity of the user-generated content based on the measured novelty.

16. The system as claimed in claim 15, including: an extractor for extracting basic features of the user-generated content; and wherein the novelty measuring component measures novelty features of the user-generated content; and the predictor predicts the popularity based on the basic features and novelty features.

17. The system as claimed in claim 15, wherein the predictor predicts the expected number of references to the user-generated content using a binary classifier.

18. The system as claimed in claim 15, wherein the novelty measuring component includes a self novelty component for measuring a relative novelty of the user-generated content with respect to the contribution history of the same user in a given time period.

19. The system as claimed in claim 15, wherein the novelty measuring component includes a contemporaneous novelty component for measuring a relative novelty of the user-generated content with respect to user-generated content of other users in a given time period.

20. The system as claimed in claim 15, wherein the novelty measuring component includes a discussion novelty component for measuring a relative novelty of the user-generated content with respect to the references by other users to the user-generated content.

21. The system as claimed in claim 15, wherein the user-generated content is a blog post and the novelty measuring component includes:
a self novelty component for measuring a relative novelty of the blog post with respect to blog post in the same blog in a given time period;
a contemporaneous novelty component for measuring a relative novelty of the blog post with respect to blog posts in other blogs in a given time period; and
a discussion novelty component for measuring a relative novelty of the blog post with respect to comments on the blog post.

22. The system as claimed in claim 15, wherein the user-generated content is an article and the novelty measuring component includes:
a self novelty measuring component for measuring a relative novelty of the article with respect to articles by the same author in a given time period;
a contemporaneous novelty component for measuring a relative novelty of the article with respect to articles by other authors in a given time period.

23. The system as claimed in claim 1, including a source history retriever for retrieving the contribution history of the same user in a given time period using a source identification of the user-generated content.

24. A service to a customer over a network for popularity prediction of user-generated content, comprising:
measuring the novelty of a user-generated content;
predicting the popularity of the user-generated content based on the measured novelty;
wherein said steps are implemented in either:
computer hardware configured to perform said identifying, tracing, and providing steps, or
computer software embodied in a non-transitory, tangible, computer-readable storage medium.
